(19) United States
(12) Patent Application Publication
(10) Pub. No.: US 2024/0370907 A1
(43) Pub. Date: Nov. 7, 2024

(54) MACHINE LEARNING GENERATED RANKING OF USER REVIEWS

(71) Applicant: Airbnb, Inc., San Francisco, CA (US)

(72) Inventors: Xiaoxin Yin, San Jose, CA (US); Pei Xiong, San Francisco, CA (US); Karen Guo, Phoenix, AZ (US); Sherry Therese Chen, San Mateo, CA (US); Do-kyum Kim, Mountain View, CA (US); Colleen Erin Joyce Thom, Daly City, CA (US); David John Muro, II, San Rafael, CA (US); Shuai Chen, Sammamish, WA (US); Jian De Jiang, Mclean, VA (US); Wa'el Belkasim, Roswell, GA (US)

(21) Appl. No.: 18/142,172

(22) Filed: May 2, 2023

(51) Int. Cl. G06Q 30/0282; G06N 3/0455

(52) U.S. Cl. CPC G06Q 30/0282; G06N 3/0455

(57) ABSTRACT

Systems and methods herein describe ranking reviews that specify details of a host user. The described systems and methods access a set of reviews associated with a host user and listing data, and for each review in the set of reviews, generate a first relevancy score associated with the host user and a second relevancy score associated with the listing data using a transformer machine learning model, determine a first rank score for the review based on the first relevancy score. The systems and methods cause display of the set of reviews in an order based on the associated first rank score on a graphical user interface of a computing device.

### TECHNICAL FIELD

Embodiments herein generally relate to machine learning. More specifically, but not by way of limitation, systems and methods herein describe machine learning-generated ranking of user reviews.

### BACKGROUND

Users of online booking systems utilize reviews and ratings to make informed decisions before purchasing a good or service. High fidelity reviews impact the overall performance of such online booking systems.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 illustrates a process for ranking reviews that pertain to a host user, in accordance with one example.

FIG. 3 is an illustration of a host profile, in accordance with one example.

FIG. 4 is an illustration of a user interface associated with a host profile that is displayed within a listing network platform, in accordance with one example.

FIG. 5 is an illustration of a user interface associated with a host profile that is displayed within a listing network platform, in accordance with one example.

FIG. 6 is an illustration of a host profile on a listing network platform.

FIG. 7 is a diagrammatic representation of a machine in the form of a computer system within which a set of instructions may be executed to cause the machine to perform any one or more of the methodologies discussed herein, according to some examples.

FIG. 8 is a block diagram showing a software architecture within which examples may be implemented.

### DETAILED DESCRIPTION

The following paragraphs describe systems and methods for ranking reviews associated with a host user on a listing network platform. The listing network platform allows host users to list or publish their homes or hotels for temporary stays. Guest users may use the listing network platform to book temporary stays at a given home or hotel. The listing network platform presents multiple listing options on a graphical user interface in response to a search query by the guest user.

A guest user may select a listing option to view details about the listing and about the host associated with the listing. For example, the details may include reviews that specifically discuss the host. Such reviews may provide the guest user with a better understanding of the host user and may guide their decision as to whether to stay at a listing hosted by the host user or not. The technical problem of identifying reviews that discuss the host can be solved by way of machine learning.

Proposed solutions describe a transformer machine learning model that analyzes a review to determine if the review is primarily discussing the host or the listing. If a review is primarily discussing the host, then that review will be ranked highly for display among other reviews. Reviews that discuss the host may include language relating to hospitality by the host, communication with the host, personality features and traits of the host, and the host's ability to accommodate to certain conditions.

The output of the transformer machine learning model is a host relevancy score and a listing relevancy score for each review. The reviews are ranked based on the host relevancy score, and those with a higher host relevancy score are prioritized for display.

In some examples, in addition to the transformer machine learning model, the reviews may also be prioritized for display based on a sentiment machine learning model. The sentiment machine learning model identifies a sentiment associated with the review: positive, negative or neutral. For example, if a host has a high rating, the listing network platform may choose to prioritize display of positive reviews. Similarly, if a host has a low rating, the listing network platform may choose to prioritize display of negative reviews.

In some examples, in addition to the transformer machine learning model and the sentiment machine learning model, the reviews may be prioritized for display based on a name detection machine learning model. The name detection machine learning model detects if a host's name or nickname is apparent in the review. If the host's name or nickname is in the review, the name detection machine learning model outputs a higher score for that review. The listing network platform may therefore choose to prioritize display of reviews that include the host's name or nickname.

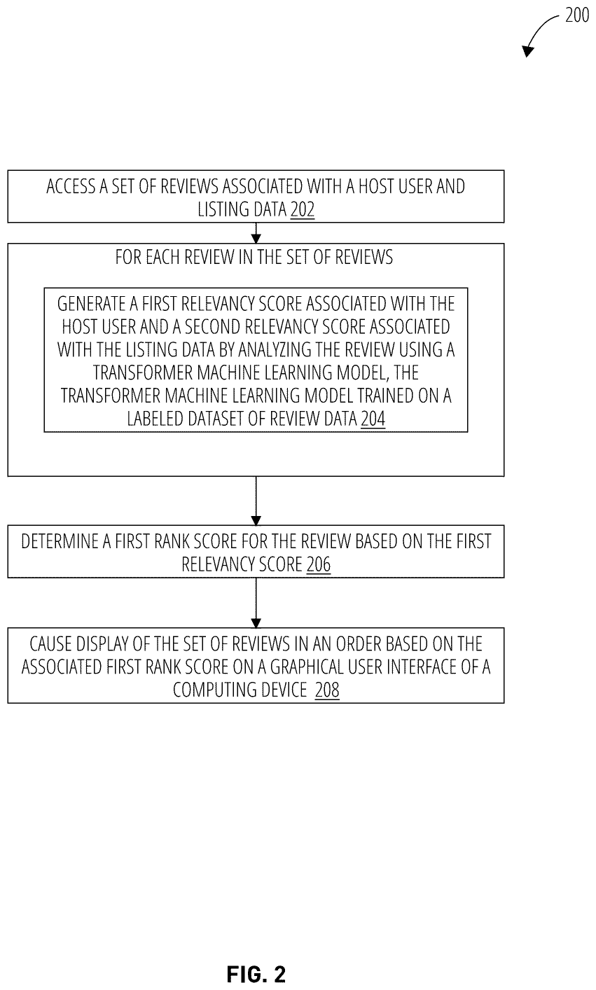

Further details regarding ranking reviews are described in FIGS. 2-6.

### Networked Computing Environment

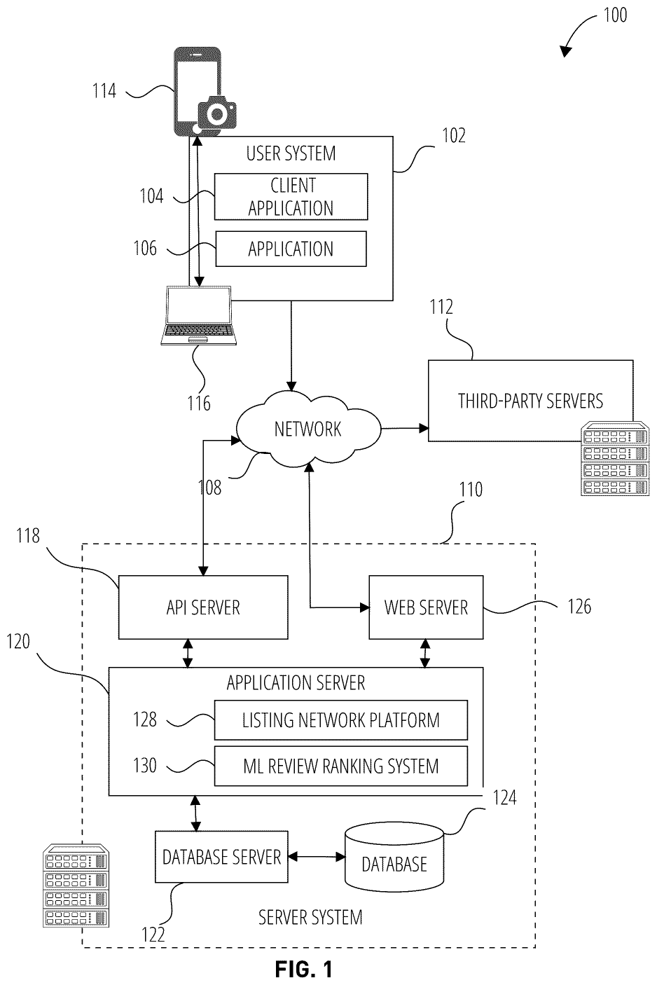

FIG. 1 is a block diagram showing an example networked system 100 for facilitating listing services (e.g., publishing goods or services for sale or barter, purchases of goods or services) over a network. The networked system 100 includes multiple user systems 102, each of which hosts multiple applications, including a client application 104 and other applications 106. Each client application 104 is communicatively coupled, via one or more communication networks including a network 108 (e.g., the Internet), to other instances of the client application 104 (e.g., hosted on respective other user systems 102), a server system 110 and third-party servers 112). A client application 104 can also communicate with locally hosted applications 106 using Applications Program Interfaces (APIs).

Each user system 102 may include multiple user devices, such as a mobile device 114 and a computer client device 116 that are communicatively connected to exchange data and messages.

A client application 104 interacts with other client applications 104 and with the server system 110 via the network 108. The data exchanged between the client applications 104 and between the client applications 104 and the server system 110 includes functions (e.g., commands to invoke functions) and payload data (e.g., text, audio, video, or other multimedia data).

In some example embodiments, the client application 104 is a reservation application for temporary stays or experiences at hotels, motels, or residences managed by other end users (e.g., a posting end user who owns a home and rents out the entire home or private room). In some implementations, the client application(s) client application 104 include various components operable to present information to the user and communicate with the networked system 100. In some embodiments, if the reservation application is included in the user system 102, then this application is configured to locally provide the user interface and at least some of the functionalities with the application configured to communicate with the networked system 100, on an as-needed basis, for data or processing capabilities not locally available (e.g., access to a database of items available for sale, to authenticate a user, to verify a method of payment). Conversely, if the reservation application is not included in the user system 102, the user system 102 can use its web browser to access the e-commerce site (or a variant thereof) hosted on the networked system 100.

The server system 110 provides server-side functionality via the network 108 to the client applications 104. While certain functions of the networked system 100 are described herein as being performed by either a client application 104 or by the server system 110, the location of certain functionality either within the client application 104 or the server system 110 may be a design choice. For example, it may be technically preferable to initially deploy particular technology and functionality within the server system 110 but to later migrate this technology and functionality to the client application 104 where a user system 102 has sufficient processing capacity.

The server system 110 supports various services and operations that are provided to the client application 104. Such operations include transmitting data to, receiving data from, and processing data generated by the client applications 104. This data may include message content, client device information, geolocation information, reservation information, transaction information, message content. Data exchanges within the networked system 100 are invoked and controlled through functions available via user interfaces (UIs) of the client application 104.

Turning now specifically to the server system 110, an Application Program Interface (API) server 118 is coupled to and provides programmatic interfaces to application server 120, making the functions of the application server 120 accessible to the client application 104, other applications 106 and third-party server 112. The application server 120 are communicatively coupled to a database server 122, facilitating access to a database 124 that stores data associated with interactions processed by the application server 120. Similarly, a web server 126 is coupled to the application server 120 and provides web-based interfaces to the application server 120. To this end, the web server 126 processes incoming network requests over the Hypertext Transfer Protocol (HTTP) and several other related protocols.

The Application Program Interface (API) server 118 receives and transmits interaction data (e.g., commands and message payloads) between the application server 120 and the user systems 102 (and, for example, client applications 104 and other application 106) and the third-party server 112. Specifically, the Application Program Interface (API) server 118 provides a set of interfaces (e.g., routines and protocols) that can be called or queried by the client application 104 and other applications 106 to invoke functionality of the application server 120. The Application Program Interface (API) server 118 exposes various functions supported by the application server 120, including account registration: login functionality.

The application server 120 host the listing network platform 128 and the ML review ranking system 130 e of which comprises one or more modules or applications and each of which can be embodied as hardware, software, firmware, or any combination thereof. The application server 120 is shown to be coupled to a database server 122 that facilitates access to one or more information storage repositories or database(s) 124.

The listing network platform 128 provides a number of publication functions and listing services to the users who access the networked system 100. While the listing network platform 128 is shown in FIG. 1 to form part of the networked system 100, it will be appreciated that, in alternative embodiments, the listing network platform 128 may form part of a web service that is separate and distinct from the networked system 100. The listing network platform 128 can be hosted on dedicated or shared server machines that are communicatively coupled to enable communications between server machines. The listing network platform 128 provides a number of publishing and listing mechanisms whereby a seller (also referred to as a “first user,” posting user, host) may list (or publish information concerning) goods or services for sale or barter, a buyer (also referred to as a “second user,” searching user, guest) can express interest in or indicate a desire to purchase or barter such goods or services, and a transaction (such as a trade) may be completed pertaining to the goods or services.

The ML review ranking system 130 ranks reviews associated with the hosts on a listing page and a host profile page. Further details of the ML review ranking system 130 are described below.

FIG. 2 illustrates a process 200 for ranking reviews that pertain to a host user, in accordance with one example. In one example, the processor in a listing network platform 128, the processor in an ML review ranking system 130, the processor in a networked system 100, the processor in the user system 102, the processor in the server system 110 or any combination thereof, can perform the operations in process 200.

In some examples, the process 200 occurs when a guest user selects a host user's profile for viewing in the listing network platform 128. In some examples, the process 200 occurs when a guest user selects a listing for viewing in the listing network platform 128. For example, a host user's profile or a listing is displayed on a user interface of a computing device and the user can select the host user's profile or listing.

In operation 202, the processor accesses a set of reviews associated with a host user and listing data. The set of reviews are associated with a single host user and may be associated with a single listing or multiple listings. For example, when the guest user selects the host user's profile for viewing via a display of a computing device, the set of reviews accessed by the processor in operation 202 include reviews associated with all of the host's listings (e.g., a plurality of listing data). However, if the guest user selects a particular listing for viewing in the listing network platform 128 via a display of a computing device, then the set of reviews accessed by the processor in operation 202 include reviews associated only with the selected listing (e.g., listing data of a single listing).

In operation 204, for each review in the set of reviews the processor generates a first relevancy score a second relevancy score using a transformer machine learning model. The processor provides the review as input to a transformer machine learning model trained to generate a first relevancy score associated with the host user and a second relevancy score associated with the listing data. A transformer machine learning model is a deep learning model that differently weights the significance of each part of the input data. Transformer models apply mathematical techniques known as attention or self-attention to detect relationships in sequential data (e.g., words in a sentence).

The transformer machine learning model is trained on a labeled dataset of reviews, where each review in the labeled dataset is given a host relevancy score and a listing relevancy score. For example, where the review discusses the host in high detail but does not mention details of the listing, the host relevancy score is high (1) and the listing relevancy score is low (0). If the review discusses a listing in high detail but does not discuss the host, the host relevancy score is low (0) and the listing relevancy score is high (1). The transformer machine learning model can be retrained regularly to improve performance of the model.

Each review is parsed into a set of segments. In some examples the processor parses each review in the set of reviews into a set of segments. Each segment in the set of segments comprises a predefined number of characters (e.g., 120 characters). The transformer machine learning model receives as input, each segment of a review and provides as output a host relevancy score and a listing relevancy score on each segment.

In operation 206, the processor determines a first rank score for the review based on the first relevancy score. For example, the first relevancy score is used as the first rank score. In operation 208, the processor causes display of the set of reviews in an order based on the associated first rank score on a graphical user interface of a computing device. For example, the processor can cause display of the set of review on a display of a computing device in an order from a highest first rank score to a lowest first rank score.

In some examples, for each review in the set of reviews, the processor further identifies a target sentiment associated with the review using a sentiment machine learning model. The processor provides the review as input to a sentiment machine learning model trained to identify a sentiment associated with the review. The sentiment is at least one of a positive sentiment, a negative sentiment or a neutral sentiment. The processor determines a rating associated with the host user and based on the rating, identifies a target sentiment. The target sentiment correlates with the rating. For example, if the rating is high, the target sentiment is positive. Similarly, if the rating is low, the target sentiment is negative. If the rating is mediocre, the target sentiment is neutral.

The processor determines whether the identified sentiment matches the target sentiment. If the identified sentiment matches the target sentiment, the processor determines a second rank score based on the identified sentiment of the review. The processor determines an average rank score based on an average of the first rank score and the second rank score and causes display of the set of reviews in an order based on the average rank score, on the graphical user interface of the computing device. For example, if the rating is high, the positive reviews are ranked higher than negative reviews. If the rating is low, the negative reviews are ranked higher than the positive reviews.

In some examples, for each review in the set of reviews, the processor further identifies a name associated with the host user using a name detector machine learning model. The processor provides the review as input to a name detector machine learning model trained to identify a name associated with the host user. For example, the name detector machine learning model identifies a name or nickname associated with the host user, such as by identifying a match with the first two characters of a host's name. The processor determines a third rank score for the review based on a positive identification of the name associated with the host user in the review. The processor determines a revised average rank score based on an average of the first rank score, the second rank score and the third rank score, and causes display of the set of reviews in an order based on the revised average rank score, on the graphical user interface of the computing device. The order can include ranking reviews from highest to lowest rank scores.

In some examples, the set of reviews is displayed on a listing page associated with a selected listing. In some examples, the set of reviews is displayed within a profile associated with the host user. In some examples, a profile of the host user further includes a set of prompt questions about the host user. The prompt questions request a description of subjects related to either the host or listings associated with the host. The prompt questions are a preset list of questions that are provided to each host user via a user interface. Each host user has the option to answer none, some, or all of the available prompt questions. If a prompt question is answered by the host user, the prompt question will be saved in association with the host user's profile and displayed on their profile.

The prompt questions can be ranked according to a predefined set of ranking rules. The predefined set of ranking rules, for example, may include that prompt questions that describe the host are displayed first, followed by prompt questions that describe listings associated with the host. The ranking rules may further require a minimum or maximum number of prompt questions that describe the host to be displayed and a minimum or maximum number of prompt questions that describe listings associated with the host to be displayed.

In some examples, a unique ordering of prompt questions on a host's profile is displayed for each guest user. The unique ordering may be random or tailored to the guest user's profile data.

A profile of the host user may also be assigned a ranking based on a size of the set of prompt questions displayed on the profile. For example, the more prompt questions answered, the higher the ranking of the host profile compared to other host profiles.

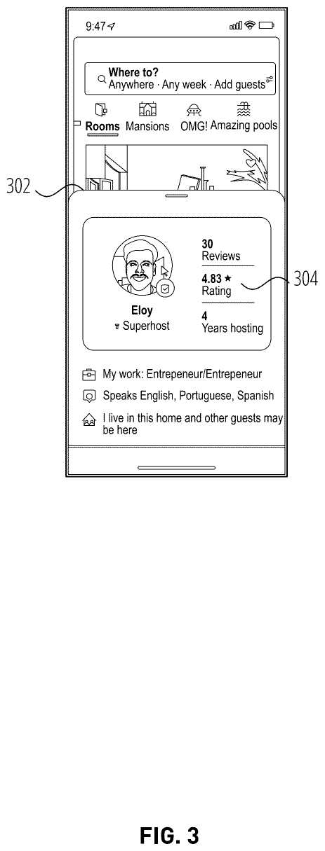

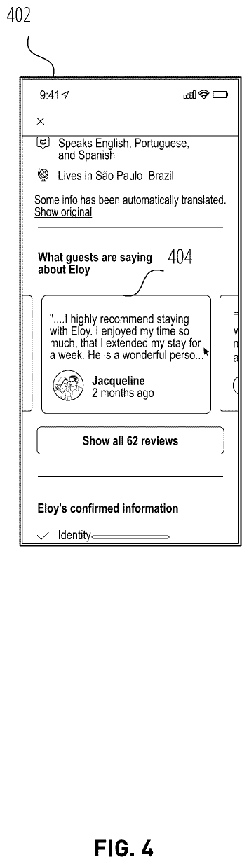

FIG. 3 is an illustration of a host profile 302 that includes a host rating 304 and information about the host. FIG. 4 is an illustration of further details of a host profile 302 that is displayed within a listing network platform 128. The further details of the host profile 302 include a portion of one or more reviews, such as the portion of review 404. The review 404 may be ranked and displayed within the user interface 402 in accordance with process 200. The displayed portions of the review 404 highlight features about a host user.

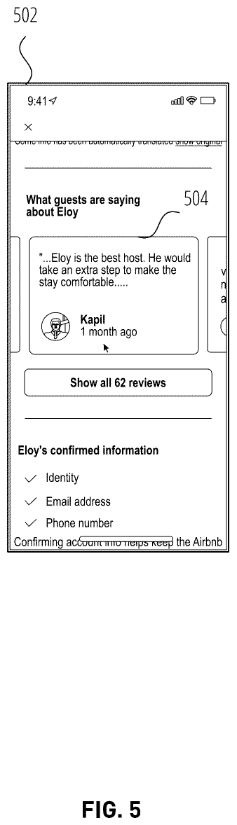

FIG. 5 is another illustration of a portion of a review 504. The review 504 may be ranked and displayed within the user interface 502 in accordance with process 200. The displayed portions of the review 504 highlight features about a host user. In some examples, the review 504 is a selectable user interface element. Upon selection of the review 504, the processor causes display of an overlay window that displays the entirety of the review 504.

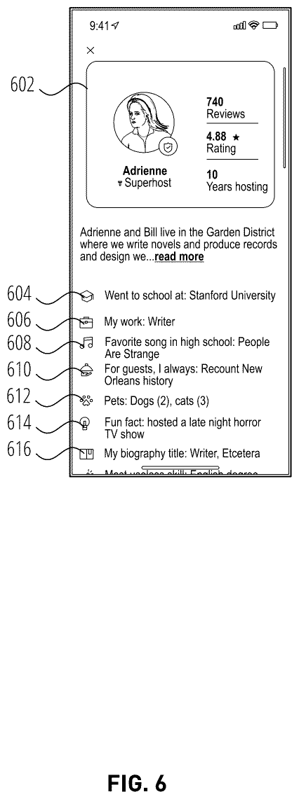

FIG. 6 is an illustration of a host profile 602 on a listing network platform 128. The host profile 602 is shown to include a plurality of prompt questions 604, 606, 608, 610, 612, 614, 616 and the corresponding answers. The prompt questions 604, 606, and 608 are ranked higher and displayed first because they pertain to the host, while prompt question 610 is ranked lower as it pertains to listings associated with the host. Although prompt questions 614 and 616 pertain to the host, they are ranked lower, because a maximum number of prompt questions pertaining to the host, have already been displayed in higher ranking positions within the host profile 602.

### Machine Architecture

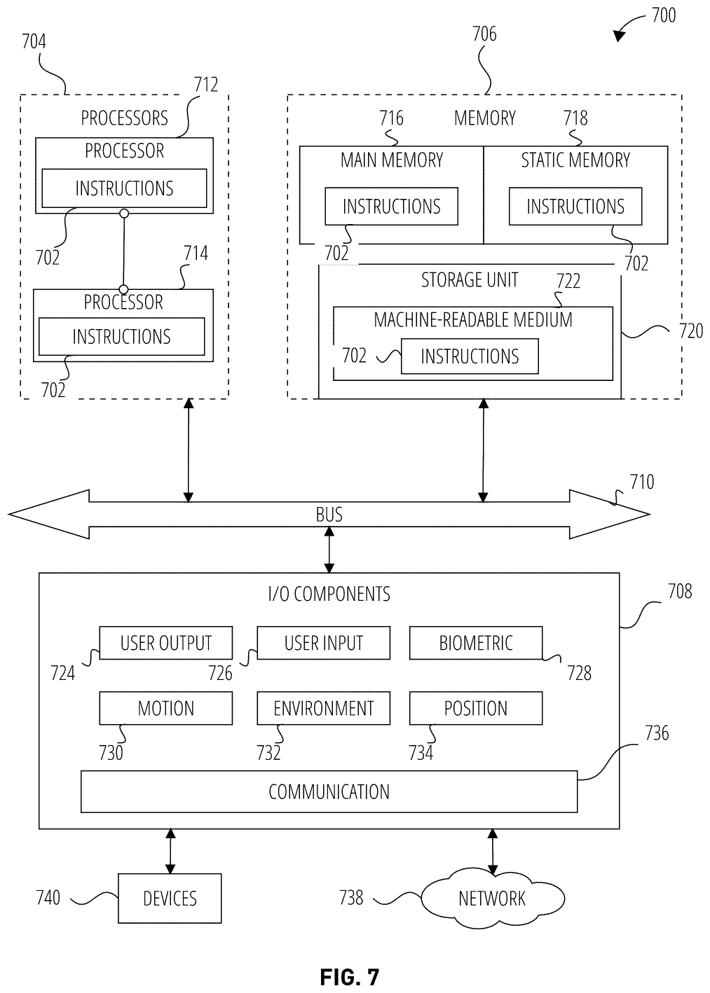

FIG. 7 is a diagrammatic representation of the machine 700 within which instructions 702 (e.g., software, a program, an application, an applet, an app, or other executable code) for causing the machine 700 to perform any one or more of the methodologies discussed herein may be executed. For example, the instructions 702 may cause the machine 700 to execute any one or more of the methods described herein. The instructions 702 transform the general, non-programmed machine 700 into a particular machine 700 programmed to carry out the described and illustrated functions in the manner described. The machine 700 may operate as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 702, sequentially or otherwise, that specify actions to be taken by the machine 700. Further, while a single machine 700 is illustrated, the term “machine” shall also be taken to include a collection of machines that individually or jointly execute the instructions 702 to perform any one or more of the methodologies discussed herein. The machine 700, for example, may comprise the user system 102 or any one of multiple server devices forming part of the server system 110. In some examples, the machine 700 may also comprise both client and server systems, with certain operations of a particular method or algorithm being performed on the server-side and with certain operations of the particular method or algorithm being performed on the client-side.

The machine 700 may include processors 704, memory 706, and input/output I/O components 708, which may be configured to communicate with each other via a bus 710. In an example, the processors 704 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 712 and a processor 714 that execute the instructions 702. The term “processor” is intended to include multi-core processors that may comprise two or more independent processors (sometimes referred to as “cores”) that may execute instructions contemporaneously. Although FIG. 7 shows multiple processors 704, the machine 700 may include a single processor with a single-core, a single processor with multiple cores (e.g., a multi-core processor), multiple processors with a single core, multiple processors with multiples cores, or any combination thereof.

The memory 706 includes a main memory 716, a static memory 718, and a storage unit 720, both accessible to the processors 704 via the bus 710. The main memory 706, the static memory 718, and storage unit 720 store the instructions 702 embodying any one or more of the methodologies or functions described herein. The instructions 702 may also reside, completely or partially, within the main memory 716, within the static memory 718, within machine-readable medium 722 within the storage unit 720, within at least one of the processors 704 (e.g., within the processor's cache memory), or any suitable combination thereof, during execution thereof by the machine 700.

The I/O components 708 may include a wide variety of components to receive input, provide output, produce output, transmit information, exchange information, capture measurements, and so on. The specific I/O components 708 that are included in a particular machine will depend on the type of machine. For example, portable machines such as mobile phones may include a touch input device or other such input mechanisms, while a headless server machine will likely not include such a touch input device. It will be appreciated that the I/O components 708 may include many other components that are not shown in FIG. 7. In various examples, the I/O components 708 may include user output components 724 and user input components 726. The user output components 724 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 726 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 708 may include biometric components 728, motion components 730, environmental components 732, or position components 734, among a wide array of other components. For example, the biometric components 728 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 730 include acceleration sensor components (e.g., accelerometer), gravitation sensor components, rotation sensor components (e.g., gyroscope).

The environmental components 732 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 734 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 708 further include communication components 736 operable to couple the machine 700 to a network 738 or devices 740 via respective coupling or connections. For example, the communication components 736 may include a network interface component or another suitable device to interface with the network 738. In further examples, the communication components 736 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 740 may be another machine or any of a wide variety of peripheral devices (e.g., a peripheral device coupled via a USB).

Moreover, the communication components 736 may detect identifiers or include components operable to detect identifiers. For example, the communication components 736 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 736, such as location via Internet Protocol (IP) geolocation, location via Wi-Fi® signal triangulation, location via detecting an NFC beacon signal that may indicate a particular location, and so forth.

The various memories (e.g., main memory 716, static memory 718, and memory of the processors 704) and storage unit 720 may store one or more sets of instructions and data structures (e.g., software) embodying or used by any one or more of the methodologies or functions described herein. These instructions (e.g., the instructions 702), when executed by processors 704, cause various operations to implement the disclosed examples.

The instructions 702 may be transmitted or received over the network 738, using a transmission medium, via a network interface device (e.g., a network interface component included in the communication components 736) and using any one of several well-known transfer protocols (e.g., hypertext transfer protocol (HTTP)). Similarly, the instructions 702 may be transmitted or received using a transmission medium via a coupling (e.g., a peer-to-peer coupling) to the devices 740.

### Software Architecture

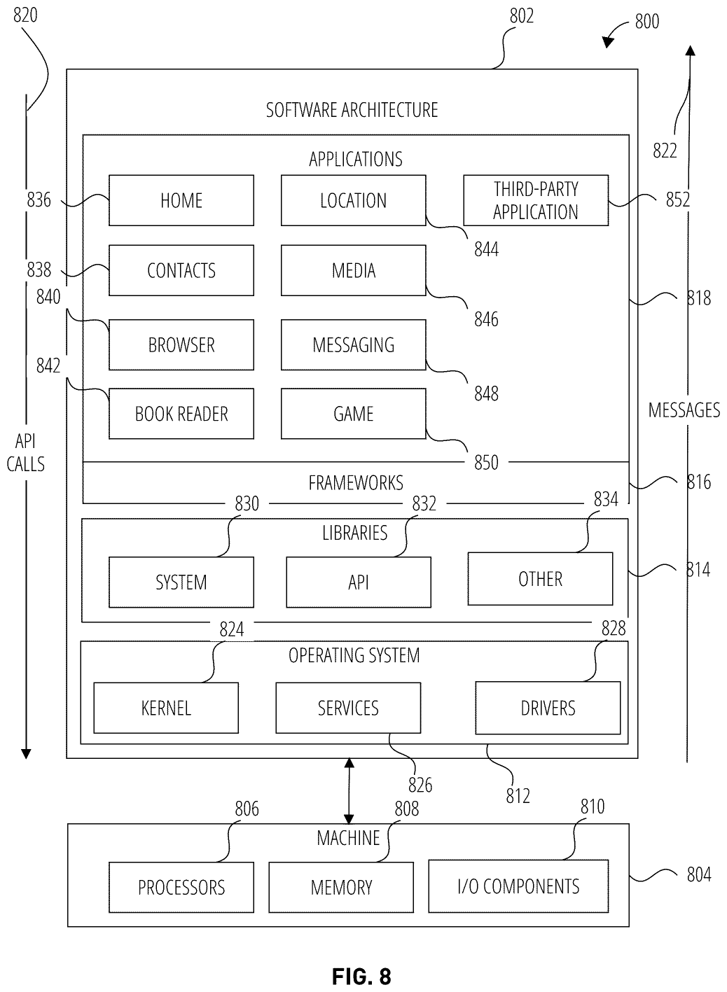

FIG. 8 is a block diagram 800 illustrating a software architecture 802, which can be installed on any one or more of the devices described herein. The software architecture 802 is supported by hardware such as a machine 804 that includes processors 806, memory 808, and I/O components 810. In this example, the software architecture 802 can be conceptualized as a stack of layers, where each layer provides a particular functionality. The software architecture 802 includes layers such as an operating system 812, libraries 814, frameworks 816, and applications 818. Operationally, the applications 818 invoke API calls 820 through the software stack and receive messages 822 in response to the API calls 820.

The operating system 812 manages hardware resources and provides common services. The operating system 812 includes, for example, a kernel 824, services 826, and drivers 828. The kernel 824 acts as an abstraction layer between the hardware and the other software layers. For example, the kernel 824 provides memory management, processor management (e.g., scheduling), component management, networking, and security settings, among other functionalities. The services 826 can provide other common services for the other software layers. The drivers 828 are responsible for controlling or interfacing with the underlying hardware. For instance, the drivers 828 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 814 provide a common low-level infrastructure used by the applications 818. The libraries 814 can include system libraries 830 (e.g., C standard library) that provide functions such as memory allocation functions, string manipulation functions, mathematic functions, and the like. In addition, the libraries 814 can include API libraries 832 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 814 can also include a wide variety of other libraries 834 to provide many other APIs to the applications 818.

The frameworks 816 provide a common high-level infrastructure that is used by the applications 818. For example, the frameworks 816 provide various graphical user interface (GUI) functions, high-level resource management, and high-level location services. The frameworks 816 can provide a broad spectrum of other APIs that can be used by the applications 818, some of which may be specific to a particular operating system or platform.

In an example, the applications 818 may include a home application 836, a contacts application 838, a browser application 840, a book reader application 842, a location application 844, a media application 846, a messaging application 848, a game application 850, and a broad assortment of other applications such as a third-party application 852. The applications 818 are programs that execute functions defined in the programs. Various programming languages can be employed to create one or more of the applications 818, structured in a variety of manners, such as object-oriented programming languages (e.g., Objective-C, Java, or C++) or procedural programming languages (e.g., C or assembly language). In a specific example, the third-party application 852 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 852 can invoke the API calls 820 provided by the operating system 812 to facilitate functionalities described herein.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

What is claimed is:

1. A system comprising:
at least one processor;
at least one memory component storing instructions that, when executed by the at least one processor, cause the at least one processor to perform operations comprising:
accessing a set of reviews associated with a host user and listing data;
for each review in the set of reviews:
generating a first relevancy score associated with the host user and a second relevancy score associated with the listing data by analyzing the review using a transformer machine learning model, the transformer machine learning model trained on a labeled dataset of review data; and
determining a first rank score for the review based on the first relevancy score; and
causing display of the set of reviews in an order based on a first rank score for each review in the set of reviews, on a graphical user interface of a computing device.

2. The system of claim 1, wherein the set of reviews is displayed within a profile associated with the host user.

3. The system of claim 2, wherein display of the profile associated with the host user further comprises a set of prompt questions about the host user.

4. The system of claim 3, wherein the prompt questions are ranked according to a predefined set of ranking rules.

5. The system of claim 3, wherein the profile of the host user is ranked based on a size of the set of prompt questions displayed on the profile.

6. The system of claim 1, further comprising:
parsing each review in the set of reviews into a set of segments, wherein each segment in the set of segments comprises a predefined number of characters; and
providing each segment of each review as input to the transformer machine learning model.

7. The system of claim 1, wherein each review in the set of reviews is associated with listing data from a plurality of listing data.

8. The system of claim 1, further comprising:
for each review in the set of reviews:
identifying a sentiment associated with the review by analyzing the review using a sentiment machine learning model, the sentiment comprising at least one of a positive sentiment, a negative sentiment or a neutral sentiment;
determining a rating associated with the host user;
based on the rating, identifying a target sentiment, the target sentiment correlating with the rating;
determining a second rank score for the review based on the identified sentiment of the review matching the target sentiment; and
determining an average rank score based on an average of the first rank score and the second rank score; and
wherein causing display of the set of reviews in an order is based on the average rank score for each review in the set of reviews.

9. The system of claim 8, further comprising:
for each review in the set of reviews:
identifying a name associated with the host user by analyzing the review using a name detector machine learning model;
determining a third rank score for the review based on a positive identification of the name associated with the host user in the review;
determining a revised average rank score based on an average of the first rank score, the second rank score and the third rank score; and
wherein causing display of the set of reviews in an order is based on the revised average rank score for each review in the set of reviews, on the graphical user interface of the computing device.

10. A method comprising:
accessing a set of reviews associated with a host user and listing data;
for each review in the set of reviews,
providing the review as input to a transformer machine learning model trained to generate a first relevancy score associated with the host user and a second relevancy score associated with the listing data, the transformer machine learning model trained on a labeled dataset of review data;
determining a first rank score for the review based on the first relevancy score; and
causing display of the set of reviews in an order based on the associated first rank score on a graphical user interface of a computing device.

11. The method of claim 10, further comprising:
parsing each review in the set of reviews into a set of segments, wherein each segment in the set of segments comprises a predefined number of characters; and
providing each segment of each review as input to the transformer machine learning model.

12. The method of claim 10, wherein each review in the set of reviews is associated with a same listing data.

13. The method of claim 10, further comprising:
for each review in the set of reviews,
providing the review as input to a sentiment machine learning model trained to identify a sentiment associated with the review, the sentiment comprising at least one of a positive sentiment, a negative sentiment or a neutral sentiment;
determining a rating associated with the host user;
based on the rating, identifying a target sentiment, the target sentiment correlating with the rating;
determining a second rank score for the review based on the identified sentiment of the review matching the target sentiment;
determining an average rank score based on an average of the first rank score and the second rank score; and
causing display of the set of reviews in a second order based on the average rank score on the graphical user interface of the computing device.

14. The method of claim 13, wherein a high rating associated with the host user correlates with a positive target sentiment and wherein a low rating associated with the host user correlates with a negative target sentiment.

15. The method of claim 13, further comprising:
for each review in the set of reviews,
providing the review as input to a name detector machine learning model trained to identify a name associated with the host user;
determining a third rank score for the review based on a positive identification of the name associated with the host user in the review;
determining a revised average rank score based on an average of the first rank score, the second rank score and the third rank score; and
causing display of the set of reviews in a third order based on the revised average rank score on the graphical user interface of the computing device.

16. A non-transitory computer-readable storage medium storing instructions that, when executed by at least one processor, cause the at least one processor to perform operations comprising:
accessing a set of reviews associated with a host user and listing data;
for each review in the set of reviews,
providing the review as input to a transformer machine learning model trained to generate a first relevancy score associated with the host user and a second relevancy score associated with the listing data, the transformer machine learning model trained on a labeled dataset of review data;
determining a first rank score for the review based on the first relevancy score; and
causing display of the set of reviews in an order based on the associated first rank score on a graphical user interface of a computing device.

17. The non-transitory computer-readable storage medium of claim 16, further comprising:
parsing each review in the set of reviews into a set of segments, wherein each segment in the set of segments comprises a predefined number of characters; and
providing each segment of each review as input to the transformer machine learning model.

18. The non-transitory computer-readable storage medium of claim 16, wherein each review in the set of reviews is associated with a same listing data.

19. The non-transitory computer-readable storage medium of claim 16, wherein each review in the set of reviews is associated with listing data from a plurality of listing data.

20. The non-transitory computer-readable storage medium of claim 16, further comprising:
for each review in the set of reviews,
providing the review as input to a sentiment machine learning model trained to identify a sentiment associated with the review, the sentiment comprising at least one of a positive sentiment, a negative sentiment or a neutral sentiment;
determining a rating associated with the host user;
based on the rating, identifying a target sentiment, the target sentiment correlating with the rating;
determining a second rank score for the review based on the identified sentiment of the review matching the target sentiment;
determining an average rank score based on an average of the first rank score and the second rank score; and
causing display of the set of reviews in a second order based on the average rank score on the graphical user interface of the computing device.
